(19) United States
(12) Patent Application Publication
(10) Pub. No.: US 2021/0341037 A1
(43) Pub. Date: Nov. 4, 2021

(54) INTERMEDIATE TRANSFER BELT STRUCTURE TO MAINTAIN AXIAL DISTANCE BETWEEN DRIVING ROLLER AND BACKUP ROLLER

(71) Applicant: HEWLETT-PACKARD DEVELOPMENT COMPANY, L.P., Spring, TX (US)

(72) Inventors: Saehoon HAN, Pangyo (KR); Jun Ho LEE, Pangyo (KR)

(21) Appl. No.: 17/284,496

(22) PCT Filed: Jan. 21, 2020
(86) PCT No.: PCT/US2020/014389

§ 371 Date: Apr. 12, 2021

(30) Foreign Application Priority Data
Mar. 21, 2019 (KR) 10-2019-0032080

(51) Int. Cl. F16H 7/12; G03G 15/16

(52) U.S. Cl. CPC F16H 7/1254; G03G 15/1615; F16H 2007/0865; G03G 2215/1614; G03G 2215/1623

(57) ABSTRACT

An intermediate transfer belt assembly includes an intermediate transfer belt, a driving roller, a backup roller, a driving frame; and a backup frame. The driving roller and the backup roller spaced apart from each other to support and move the intermediate transfer belt in a first direction. The driving frame is to rotatably support the driving roller. The backup frame is connected to the driving frame, is to rotatably support the backup roller and is to move in the first direction.

### BACKGROUND

An electrophotographic image forming apparatus forms a visible toner image on a photoconductor by supplying toner to an electrostatic latent image formed on the photoconductor, transfers the toner image to a print medium, and fixes the transferred toner image on the print medium. In order to print a color image, toner images of different colors are formed on a plurality of photoconductors. The toner images are transferred through an intermediate transfer medium to a print medium. An intermediate transfer belt is used as the intermediate transfer medium. The intermediate transfer belt is supported and circulated by a plurality of support rollers including a driving roller and a backup roller. A travel state of the intermediate transfer belt may affect the quality of the color image and the lifetime of the intermediate transfer belt.

### BRIEF DESCRIPTION OF DRAWINGS

FIG. 1 is a view illustrating a configuration of an electrophotographic image forming apparatus according to an example;

FIG. 2 is an exploded perspective view illustrating an assembly structure of an intermediate transfer belt;

FIG. 3 is an exploded perspective view of an intermediate transfer belt assembly according to an example;

FIG. 4 is an exploded perspective view illustrating a portion “C” of FIG. 3;

FIG. 5 is a detailed view of a first support; and

FIG. 6 is a detailed view of a second support.

### DETAILED DESCRIPTION OF EXAMPLES

The disclosure will now be described more fully with reference to the accompanying drawings, in which examples of the disclosure are shown. In the specification and the drawings, elements having substantially the same functions and configurations are denoted by the same reference numerals and thus a repeated explanation thereof will not be given.

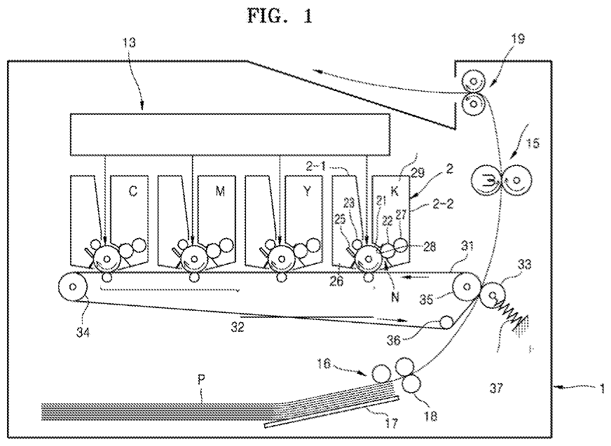

FIG. 1 is a view illustrating a configuration of an image forming apparatus that is an electrophotographic image forming apparatus according to an example. The image forming apparatus of the present example prints a color image to a print medium P by using an electrophotographic method. Referring to FIG. 1, the image forming apparatus may include a main body 1 and a plurality of development cartridges 2. The plurality of development cartridges 2 are detachably attached to the main body 1. An exposure unit 13, a transfer unit, and a fusing unit 15 are provided on the main body 1. Also, a print medium-feeding unit for loading thereon the print medium P on which an image is to be formed and feeding the print medium P is provided on the main body 1.

For color printing, the plurality of development cartridges 2 may include four development cartridges, for example, development cartridges 2C, 2M, 2Y, and 2K for developing cyan (C), magenta (M), yellow (Y), and black (K) images. C, M, Y, and K developers, for example, toners, may be respectively received in the development cartridges 2C, 2M, 2Y, and 2K. Although not shown in FIG. 1, the C, M, Y, and K toners may be respectively received in four toner supply containers and may be respectively supplied from the four toner supply containers to the development cartridges 2C, 2M, 2Y, and 2K. The image forming apparatus may further include the development cartridges 2 for receiving and developing other color toners such as light magenta toner and white toner. The following description is given assuming that the image forming apparatus includes the development cartridges 2C, 2M, 2Y, and 2K and reference letters C, M, Y, and K respectively denote elements for developing C, M, Y, and K images unless specified otherwise.

The development cartridges 2 of the present example are integrated development cartridges. The development cartridges 2C, 2M, 2Y, and 2K may be detachably attached to the main body 1 through a door (not shown). Each of the development cartridges 2 may include a photosensitive unit 2-1 and a developing unit 2-2.

The photosensitive unit 2-1 includes a photosensitive drum 21. The photosensitive drum 21 that is a photoconductor on a surface of which an electrostatic latent image is formed may include a conductive metal pipe and a photosensitive layer formed on an outer circumferential surface of the conductive metal pipe. A charging roller 23 is a charger for charging the photosensitive drum 21 to a uniform surface electric potential. A charging brush or a corona charger, instead of the charging roller 23, may be used. The photosensitive unit 2-1 may further include a cleaning roller (not shown) for removing a foreign material attached to a surface of the charging roller 23. A cleaning blade 25 is a cleaning member for removing a foreign material and toner remaining on a surface of the photosensitive drum 21 after a transfer process that is described below. Another type of cleaning device such as a rotating brush, instead of the cleaning blade 25, may be used. The foreign material and the toner removed from the photosensitive drum 21 by the cleaning blade 25 are referred to as waste toner. The waste toner is received in a waste toner receiver 26.

The developing unit 2-2 may include a toner receiver 29. The developing unit 2-2 supplies toner received in the toner receiver 29 to an electrostatic latent image formed on the photosensitive drum 21 and develops the electrostatic latent image into a visible toner image. Examples of a developing method include a one-component developing method using toner and a two-component developing method using toner and a carrier. The development cartridge 2 of the present example uses a one-component developing method. The developing roller 22 supplies toner to the photosensitive drum 21. A developing bias voltage for supplying toner to the photosensitive drum 21 may be applied to the developing roller 22. In the present example, a contact developing method in which the developing roller 22 and the photosensitive drum 21 contact each other to form a development nip N is used. A supply roller 27 supplies toner in the toner receiver 29 to a surface of the developing roller 22. To this end, a supply bias voltage may be applied to the supply roller 27. The developing unit 2-2 may further include a regulating member 28 for regulating the amount of toner supplied by the developing roller 22 to the development nip N, where the photosensitive drum 21 and the developing roller 22 contact each other. The regulating member 28 may be, for example, a doctor blade elastically contacting the surface of the developing roller 22.

The exposure unit 13 forms an electrostatic latent image on the photosensitive drum 21 by irradiating light modulated to correspond to image information to the photosensitive drum 21. A laser scanning unit (LSU) using a laser diode as a light source or a light-emitting diode (LED) exposure unit using an LED as a light source may be used as the exposure unit 13.

The transfer unit may include an intermediate transfer belt 31, intermediate transfer rollers 32, and a transfer roller 33. Toner images developed on the photosensitive drums 21 of the development cartridges 2C, 2M, 2Y, and 2K are temporarily transferred to the intermediate transfer belt 31. The intermediate transfer belt 31 is supported and circulated by support rollers 34, 35, and 36. Four intermediate transfer rollers 32 are located to face the photosensitive drums 21 of the development cartridges 2C, 2M, 2Y, and 2K with the intermediate transfer belt 31 therebetween. An intermediate transfer bias voltage for transferring the toner images developed on the photosensitive drums 21 to the intermediate transfer belt 31 is applied to the four intermediate transfer rollers 32. A corona transfer unit or a transfer unit using a pin-scorotron method, instead of the intermediate transfer roller 32, may be used. The transfer roller 33 faces the intermediate transfer belt 31. A transfer bias voltage for transferring the toner images transferred to the intermediate transfer belt 31 to the print medium P is applied to the transfer roller 33.

When a print command is received from a host (not shown), a controller (not shown) charges a surface of the photosensitive drum 21 to a uniform electric potential by using the charging roller 23. The exposure unit 13 forms an electrostatic latent image on the photosensitive drums 21 by scanning four light beams modulated to correspond to color image information to the photosensitive drums 21 of the development cartridges 2C, 2M, 2Y, and 2K. The developing rollers 22 of the development cartridges 2C, 2M, 2Y, and 2K supply C, M, Y, and K toners to the photosensitive drums 21 and develop the electrostatic latent images into visible toner images. The developed toner images are transferred to the intermediate transfer belt 31. The print medium P stacked on a loader 17 is picked up one by one by a pickup roller 16 and is fed by a feed roller 18 to a transfer nip formed by the transfer roller 33 and the intermediate transfer belt 31. The toner images transferred to the intermediate transfer belt 31 are transferred to the print medium P due to a transfer bias voltage applied to the transfer roller 33. When the print medium P passes through the fusing unit 15, the toner images are fixed to the print medium P due to heat and pressure. When the toner images are completely fixed to the print medium P, the print medium P is discharged to the outside by a discharge roller 19.

As described above, the intermediate transfer belt 31 is supported and circulated by the support rollers 34, 35, and 36. The support rollers 34 and 35 may be spaced apart from each other and may support and move the intermediate transfer belt 31 in a first direction. The support roller 36 may be located inside the intermediate transfer belt 31 and may apply a tensile force to the intermediate transfer belt 31. Hereinafter, the support rollers 34, 35, and 36 are referred to as a driving roller 34, a backup roller 35, and a tension roller 36, respectively. Also, the first direction the intermediate transfer belt 31 is moved may be referred to as a travel direction of the intermediate transfer belt 31 which may be referred to as an X-direction and a direction perpendicular to the X-direction is referred to as a Y-direction.

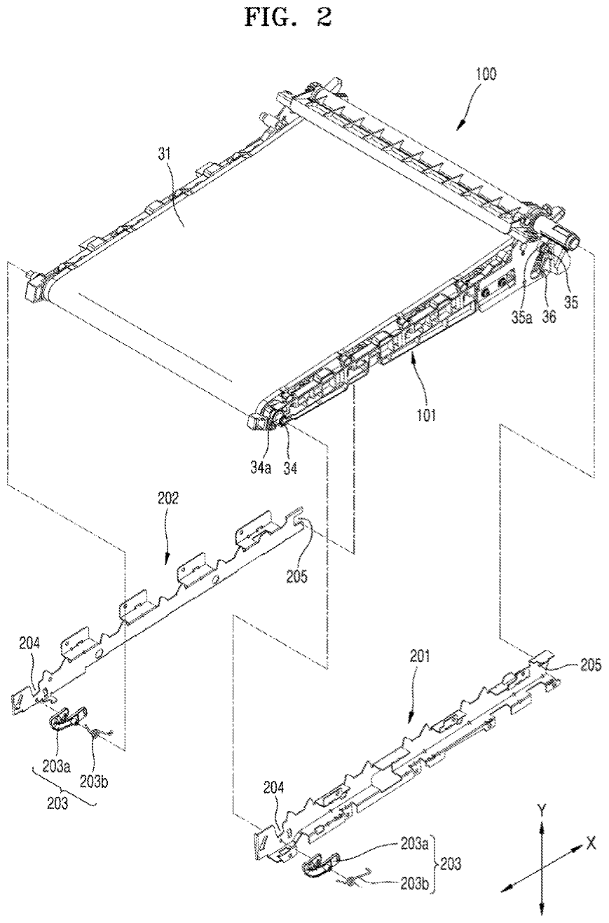

FIG. 2 is an exploded perspective view illustrating an assembly structure of the intermediate transfer belt 31. Referring to FIG. 2, an intermediate transfer belt assembly 100 including the intermediate transfer belt 31 and a pair of support brackets 201 and 202 are illustrated. The support brackets 201 and 202 are provided on the main body 1. The intermediate transfer belt assembly 100 includes a belt frame 101, the driving roller 34 and the backup roller 35 rotatably supported on the belt frame 101, and the intermediate transfer belt 31 supported and circulated by the driving roller 34 and the backup roller 35. The intermediate transfer belt assembly 100 may further include the tension roller 36 for applying a tensile force to the intermediate transfer belt 31. The tension roller 36 may be rotatably supported on the belt frame 101. The intermediate transfer rollers 32 may be rotatably supported on the belt frame 101. The intermediate transfer belt assembly 100 is mounted on the support brackets 201 and 202.

When the intermediate transfer belt assembly 100 is mounted on the support brackets 201 and 202, a position of the driving roller 34 in the main body 1 is determined. The driving roller 34 is connected to a driving motor (not shown) provided on the main body 1 via a driving member such as a gear. When a position of the driving roller 34 in the main body 1 is not precise, a driving force may be non-uniformly transmitted from the driving motor and the intermediate transfer belt 31 may unstably travel.

The driving roller 34 and the backup roller 35 have to be parallel to each other. In other words, an axial distance between the driving roller 34 and the backup roller 35 may be uniform in an entire axial direction. When the axial distance between the driving roller 34 and the backup roller 35 is not uniform in the axial direction, a travel speed of the intermediate transfer belt 31 may become non-uniform in the axial direction, thereby leading to skew. When the intermediate transfer belt 31 skews, it may mean that the intermediate transfer belt 31 travels by leaning to a side in the axial direction without traveling at a constant position in the axial direction.

When the intermediate transfer belt 31 non-uniformly travels, a color registration error may occur when color toner images are transferred to the intermediate transfer belt 31, thereby reducing the quality of a color image.

An end portion of the intermediate transfer belt 31 in the axial direction may conflict with the belt frame 101 or the like due to the skew, thereby damaging the intermediate transfer belt 31. Also, a tensile force applied to the intermediate transfer belt 31 may become non-uniform in the axial direction and fatigue of the intermediate transfer belt 31 may be accumulated, thereby damaging the intermediate transfer belt 31.

As such, a positional precision of the driving roller 34 and the backup roller 35 may affect image quality and the operation reliability of the image forming apparatus. The positional precision of the driving roller 34 and the backup roller 35 may be affected by many factors such as a processing error and an assembly error of members constituting the intermediate transfer belt assembly 100, a processing error and an assembly positional error of the support brackets 201 and 202 in the main body 1, and an assembly error between the intermediate transfer belt assembly 100 and the support brackets 201 and 202.

For example, in a structure in which the driving roller 34 and the backup roller 35 are assembled with the belt frame 101 to have fixed positions, due to a manufacturing error of the belt frame 101, an error may occur in positions of the driving roller 34 and the backup roller 35 in the belt frame 101. Also, due to a manufacturing error of the support brackets 201 and 202 and an assembly error between the support brackets 201 and 202 and the intermediate transfer belt assembly 100, an error may occur in positions of the driving roller 34 and the backup roller 35 in the main body 1. When various errors are accumulated, it is not easy to ensure a positional precision of the driving roller 34 and the backup roller 35.

In an example, in a structure in which a position of the backup roller 35 is adjusted by using a jig when assembling the backup roller 354 to the belt frame 101, as the amount of production increases and the jig ages, a positional precision of the backup roller 35 in the belt frame 101 may be reduced. Also, even in this case, a manufacturing error of the support brackets 201 and 202 and an assembly error between the support brackets 201 and 202 and the intermediate transfer belt assembly 100 may still affect positions of the driving roller 34 and the backup roller 35 in the main body 1.

Accordingly, there is a demand for an intermediate transfer belt structure that may reduce factors affecting a positional precision of the driving roller 34 and the backup roller 35.

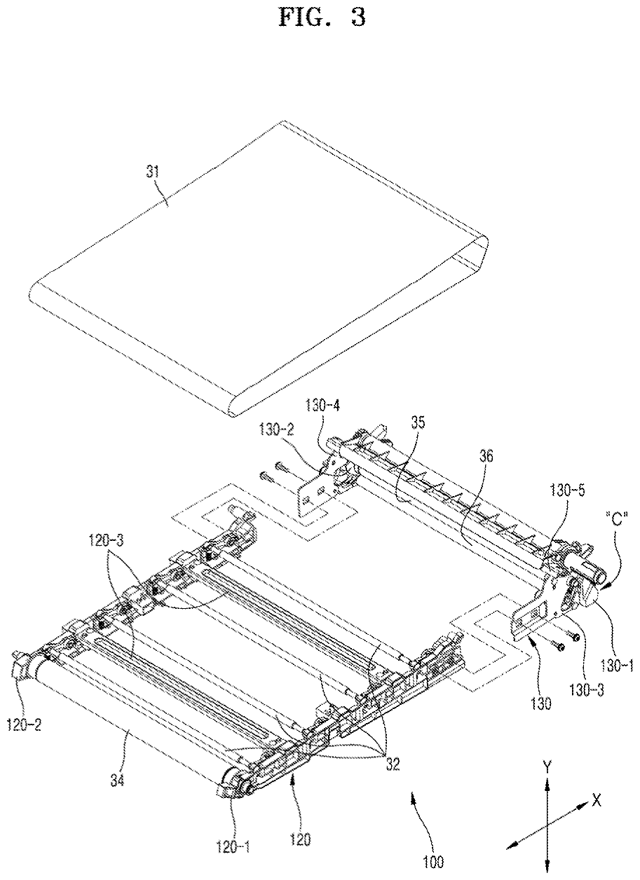

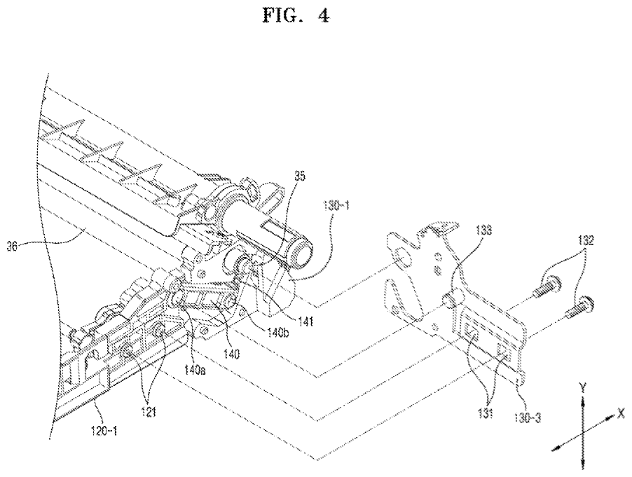

According to the present example, the belt frame 101 rotatably supports the driving roller 34 at a fixed position and movably supports the backup roller 35 in the X-direction. FIG. 3 is an exploded perspective view of the intermediate transfer belt assembly 100 according to an example. FIG. 4 is an exploded perspective view illustrating a portion “C” of FIG. 3.

Referring to FIG. 3, the belt frame 101 may include a driving frame 120 on which the driving roller 34 is rotatably supported and a backup frame 130 on which the backup roller 35 is rotatably supported. The backup frame 130 is connected to the driving frame 120 to move in the X-direction.

The driving frame 120 may include a pair of sub-frames 120-1 and 120-2 spaced apart from each other in an axial direction of the driving roller 34, and at least one connecting bracket 120-3 extending in the axial direction and connecting the sub-frames 120-1 and 120-2. The driving roller 34 is rotatably supported at an end portion of the driving frame 120, that is, an end portion far from the backup frame 130. The driving roller 34 has a fixed position in the driving frame 120.

The backup frame 130 may include a pair of sub-frames 130-1 and 130-2 spaced apart from each other in an axial direction of the backup roller 35, a pair of sub-brackets 130-3 and 130-4 respectively connected to the sub-frames 130-1 and 130-2 and extending to the sub-frames 120-1 and 120-2, and at least one connecting bracket 130-5 extending in the axial direction and connecting the sub-frames 130-1 and 130-2. The backup roller 35 is rotatably supported at an end portion of the backup frame 130, that is, an end portion far from the driving frame 120. The backup roller 35 has a fixed position in the backup frame 130.

Referring to FIGS. 3 and 4, the backup frame 130 is connected to the driving frame 120 to move in a travel direction X. For example, a slot 131 extending in the X-direction may be formed in one of the driving frame 120 and the backup frame 130, and a protrusion 121 inserted into the slot 131 may be formed on the remaining one of the driving frame 120 and the backup frame 130. In the present example, the protrusion 121 is provided around an end portion of each of the sub-frames 120-1 and 120-2 close to the backup frame 130, and the slot 131 into which the protrusion 121 is inserted is formed in each of the sub-brackets 130-3 and 130-4. A separation-preventing member 132 prevents the protrusion 121 from being separated from the slot 131. In the present example, the separation-preventing member 132 is fastened to the protrusion 121. For example, the separation-preventing member 132 may be a screw whose head has a diameter greater than a width of the slot 131. The screw may pass through the slot 131 and may be fastened to the protrusion 121. In this structure, the backup frame 130 may move in the X-direction relative to the driving frame 120, and a position of the backup roller 35 has a degree of freedom in the X-direction relative to the driving roller 34.

As described above, the tension roller 36 is located inside the intermediate transfer belt 31 and applies a tensile force to the intermediate transfer belt 31. The tension roller 36 contacts an inner circumferential surface of the intermediate transfer belt 31 and applies a tensile force to the intermediate transfer belt 31 by elastically pushing the intermediate transfer belt 31 outward. The tension roller 36 may be elastically and pivotably supported on the belt frame 101. In an example, referring to FIG. 4, first end portions 140a of a pair of pivoting arms 140 are pivotably supported on the backup frame 130, and both end portions of the tension roller 36 are rotatably supported on second end portions 140b of the pivoting arms 140. In the present example, a support shaft 133 is provided on each of the sub-brackets 130-3 and 130-4, the first end portions 140a of the pivoting arms 140 are fit around the support shafts 133 and are pivotably supported on the support shafts 133. A pair of first springs 141 apply an elastic force to the pivoting arms 140 so that the pivoting arms 140 pivot and the tension roller 36 contacts the inner circumferential surface of the intermediate transfer belt 31. In an example, the first springs 141 may include compression coil springs having first and second end portions respectively supported on the second end portions 140b of the pivoting arms 140 and the sub-frames 130-1 and 130-2.

As described above, the intermediate transfer belt assembly 100 is mounted on the support brackets 201 and 202. Referring back to FIG. 2, the support brackets 201 and 202 include first and second supports 204 and 205 respectively supporting both end portions of the driving roller 34 and both end portions of the backup roller 35.

The driving roller 34 is supported on the first supports 204 to be detachably attached to the first supports 204 in a vertical direction, that is, the Y-direction. A direction in which the driving roller 34 is attached to/detached from the first supports 204 may not be the Y-direction and may be any direction having a sufficient angle from the X-direction.

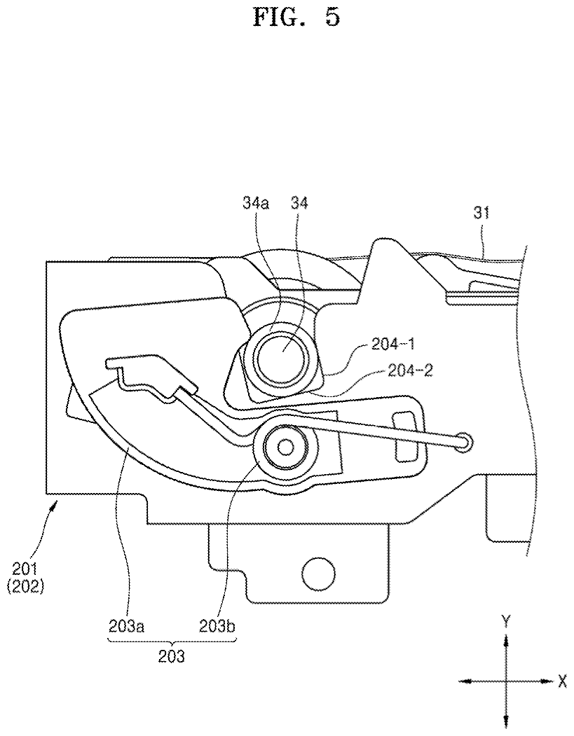

FIG. 5 is a detailed view of the first support 204. Referring to FIG. 5, the first support 204 may be formed by being obliquely cut to have an acute angle from the Y-direction. The first support 204 may include first and second regulators 204-1 and 204-2 for respectively regulating positions of the driving roller 34 in the X-direction and the Y-direction. Both end portions of the driving roller 34 are pressed onto the first supports 204 by a pair of pressurization members 203. For example, both end portions of the driving roller 34 are pressed onto the first and second regulators 204-1 and 204-2 by the pressurization members 203. In an example, the pressurization members 203 may include pivoting members 203a that are pivotably provided on the support brackets 201 and 202 and contact end portions of the driving roller 34, and second springs 203b that apply an elastic force to the pivoting members 203a so that the pivoting members 203a pivot in a direction to press the driving roller 34 onto the first and second regulators 204-1 and 204-2. Both end portions of the driving roller 34 may be supported on the first supports 204 with bearings 34a, for example, oil-impregnated sintered bearings, therebetween. The pivoting members 203a may contact the bearings 34a and may press the driving roller 34 onto the first and second regulators 204-1 and 204-2. The second springs 203b may include torsion coil springs having first and second end portions respectively supported on the pivoting members 203a and the support brackets 201 and 202.

In this structure, when both end portions of the driving roller 34 are inserted into the first supports 204 and the pressurization members 203 press the both end portions of the driving roller 34 onto the first supports 204, movements of the driving roller 34 in the X-direction and the Y-direction are regulated and positions of the driving roller 34 in the X-direction and the Y-direction are fixed. Accordingly, a position of the driving roller 34 in the main body 1 may be determined by positions of the first supports 204, and a position of the driving roller 34 is affected by a manufacturing precision of the support brackets 201 and 202. The support brackets 201 and 202 may be manufactured by press working a metal plate. Shapes of the first supports 204 of the support brackets 201 and 202 are the same. When the first supports 204 of the support brackets 201 and 202 are processed by using the same press mold core, a processing error of the first and second supports 204 and 205 of the support brackets 201 and 202 may be almost “0”. Accordingly, a positional precision of the driving roller 34 in the main body 1 may be easily ensured and a driving force of a driving motor may be stably transmitted to the driving roller 34, thereby enabling the intermediate transfer belt 31 to stably travel. Also, a color registration error caused by a non-uniform travel of the intermediate transfer belt 31 may be reduced.

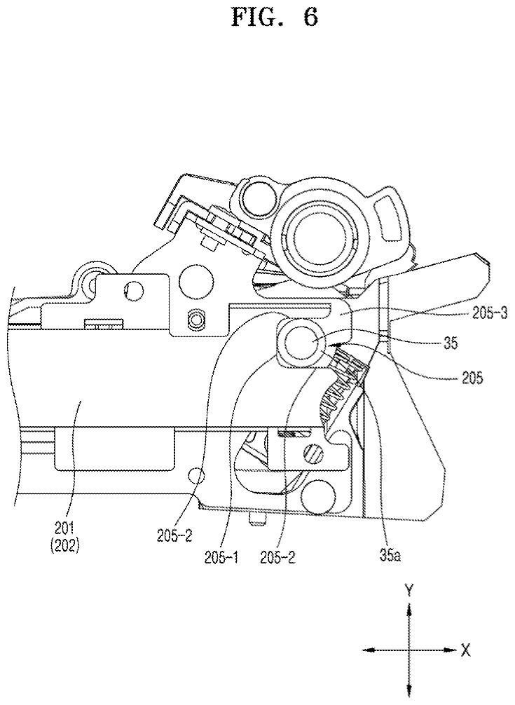

The backup roller 35 is supported on the second supports 205 to move (be attached/detached) in the X-direction. FIG. 6 is a detailed view of one of the second supports 205. Referring to FIG. 6, the second support 205 may be formed by being cut in the X-direction. The backup roller 35 may be supported on the second support 205 with a bearing 35a, for example, an oil-impregnated sintered bearing, therebetween. The second support 205 may include third and fourth regulators 205-1 and 205-2 for respectively regulating positions of the backup roller 35 in the X-direction and the Y-direction. For example, the fourth regulator 205-2 may include a pair of walls spaced apart from each other in the Y-direction and extending in the X-direction, and the third regulator 205-1 may include a wall that connects the one pair of walls in the Y-direction. The backup roller 35 may be pressed onto the second support 205 in the X-direction by the transfer roller 33. Referring to FIG. 1, the transfer roller 33 faces the backup roller 35 with the intermediate transfer belt 31 therebetween. A third spring 37 applies an elastic force to the transfer roller 33 so that the backup roller 35 is pressed onto the second support 205 in the X-direction. The transfer roller 33 may press the backup roller 35 onto the third regulator 205-1. The transfer roller 33 may press the backup roller 35 onto the third regulator 205-1 and the fourth regulator 205-2. In this structure, movements of the backup roller 35 in the X-direction and the Y-direction are regulated, and positions of the backup roller 35 in the X-direction and the Y-direction are determined.

Because the backup frame 130 may move in the X-direction relative to the driving frame 120 as described above, an axial distance between the driving roller 34 and the backup roller 35 in the intermediate transfer belt assembly 100 is flexible. When the intermediate transfer belt assembly 100 is mounted on the support brackets 201 and 202 in the main body 1, the driving roller 34 is supported on the first supports 204 and the backup roller 35 is supported on the second supports 205. First, both end portions of the driving roller 34 are inserted into the first supports 204 in the Y-direction. Both end portions of the backup roller 35 are aligned with openings 205-3 of the second supports 205 by moving the backup frame 130 away from the driving frame 120 in the X-direction. Next, both end portions of the backup roller 35 may be inserted into the second supports 205 by pushing the backup frame 130 toward the driving frame 120 in the X-direction. Because the backup frame 130 may move in the X-direction relative to the driving frame 120, both end portions of the driving roller 34 and both end portions of the backup roller 35 may be easily inserted into the first and second supports 204 and 205, respectively.

A position of the driving roller 34 is fixed by pressing both end portions of the driving roller 34 onto the first supports 204 by using the pressurization member 203. Because a position of the driving roller 34 is determined by positions of the first supports 204 of the support brackets 201 and 202 as described above, a positional precision of the driving roller 34 in the main body 1 may be easily ensured and a driving force of the driving motor of the driving roller 34 may be stably transmitted, thereby enabling the intermediate transfer belt 31 to stably travel.

When both end portions of the backup roller 35 are mounted on the second supports 205, the transfer roller 33 presses the backup roller 35 onto the second supports 205 with the intermediate transfer belt 31 therebetween due to an elastic force of the third spring 37. In this case, the backup frame 130 moves to the driving frame 120 in the X-direction, and the backup roller 35 is guided by the fourth regulators 205-2 to the third regulators 205-1. When both end portions of the backup roller 35 contact the third regulators 205-1, a position of the backup roller 35 in the main body 1 is determined.

A position of the backup roller 35 in the main body 1 is not affected by the intermediate transfer belt assembly 100 itself and is affected by the second supports 205 of the support brackets 201 and 202. As described above, the support brackets 201 and 202 may be manufactured by press working a metal plate. Shapes of the second supports 205 of the support brackets 201 and 202 are the same. When the second supports 205 of the support brackets 201 and 202 are processed by using the same press mold core, a processing error of the second supports 205 of the support brackets 201 and 202 may be almost “0”. Accordingly, a positional precision of the backup roller 35 in the main body 1 may be easily ensured.

As such, positions of the driving roller 34 and the backup roller 35 in the main body 1 are affected by a manufacturing precision of the support brackets 201 and 202 and a positional precision in the main body 1 and are hardly affected by a manufacturing precision of the intermediate transfer belt assembly 100. Also, as described above, when the first and second supports 204 and 205 of the support brackets 201 and 202 are processed by using the same press mold core, a processing error of the first and second supports 204 and 205 may be almost “0”. Accordingly, a positional precision of the driving roller 34 and the backup roller 35 may be easily managed. Also, an axial distance between the driving roller 34 and the backup roller 35 may be maintained constant in an entire axial direction, the intermediate transfer belt 31 may stably travel, and skew of the intermediate transfer belt 31 may be prevented. Also, stable color registration performance may be ensured and color print images having stable quality may be obtained. Also, uneven tension or skew of the intermediate transfer belt 31 may be prevented, the risk of damage to the intermediate transfer belt 31 may be reduced, and the intermediate transfer belt 31 may reliably operate during a lifetime.

While the present disclosure has been particularly shown and described with reference to examples thereof, they are provided for illustration and it will be understood by one of ordinary skill in the art that various modifications and equivalent other examples can be made from the present disclosure. Accordingly, the true technical scope of the present disclosure is defined by the technical spirit of the appended claims.

What is claimed is:

1. An intermediate transfer belt assembly comprising:
an intermediate transfer belt;
a driving roller and a backup roller spaced apart from each other to support and move the intermediate transfer belt in a first direction;
a driving frame to rotatably support the driving roller; and
a backup frame connected to the driving frame, to rotatably support the backup roller and to move in the first direction.

2. The intermediate transfer belt assembly of claim 1, further comprising:
a slot formed in one of the driving frame and the backup frame extending in the first direction; and
a protrusion provided on another of the driving frame and the backup frame to be inserted into the slot.

3. The intermediate transfer belt assembly of claim 2, further comprising a separation-preventing member fastened to the protrusion to prevent the protrusion from separating from the slot.

4. The intermediate transfer belt assembly of claim 1, further comprising a tension roller located inside the intermediate transfer belt and to apply a tensile force to the intermediate transfer belt.

5. The intermediate transfer belt assembly of claim 4, further comprising:
a pivoting arm having a first end portion and a second end portion, the backup frame to pivotably support the first end portion and the second end portion to rotatably support the tension roller; and
a first spring to apply an elastic force to the pivoting arm to pivot the pivoting arm so the tension roller contacts an inner circumferential surface of the intermediate transfer belt.

6. An electrophotographic image forming apparatus comprising:
an intermediate transfer belt assembly comprising an intermediate transfer belt, a driving roller and a backup roller spaced apart from each other and to support and move the intermediate transfer belt in a first direction, a driving frame to rotatably support the driving roller, and a backup frame connected to the driving frame, to rotatably support the backup roller and to move in the first direction;
a pair of support brackets including a first support to support the driving roller and a second support to support the backup roller and to move in the first direction, the intermediate transfer belt assembly being mounted on the support brackets; and
a transfer roller to press the backup roller onto the second support in the first direction.

7. The electrophotographic image forming apparatus of claim 6, further comprising:
a slot formed in one of the driving frame and the backup frame extending in the first direction; and
a protrusion provided on another of the driving frame and the backup frame to be inserted into the slot.

8. The electrophotographic image forming apparatus of claim 7, further comprising a separation-preventing member fastened to the protrusion to prevent the protrusion from separating from the slot.

9. The electrophotographic image forming apparatus of claim 7, further comprising:
a tension roller located inside the intermediate transfer belt and to apply a tensile force to the intermediate transfer belt;
a pivoting arm having a first end portion and a second end portion, the backup frame to pivotably support the first end portion and the second end portion to rotatably support the tension roller; and
a first spring to apply an elastic force to the pivoting arm to pivot the pivoting arm so the tension roller contacts an inner circumferential surface of the intermediate transfer belt.

10. The electrophotographic image forming apparatus of claim 7, further comprising the driving frame pivotably supporting a plurality of intermediate transfer rollers.

11. The electrophotographic image forming apparatus of claim 6, wherein the first support comprises first and second regulators to respectively regulate a position of the driving roller in the first direction and a position of the driving roller in a direction perpendicular to the first direction,
wherein the electrophotographic image forming apparatus further comprises a pressurization member to press the driving roller onto the first and second regulators.

12. The electrophotographic image forming apparatus of claim 11, wherein the pressurization member comprises:
a pivoting member pivotably provided on the support brackets and contacting the driving roller; and
a second spring to apply an elastic force to the pivoting member to pivot the pivoting member so the driving roller is pressed onto the first and second regulators.

13. The electrophotographic image forming apparatus of claim 6, wherein the second support comprises:
a third regulator to regulate a position of the backup roller in the first direction; and
a fourth regulator to movably support the backup roller in the first direction and regulate a position of the backup roller in a direction perpendicular to the first direction.

14. The electrophotographic image forming apparatus of claim 13, wherein the transfer roller faces the backup roller with the intermediate transfer belt therebetween,
wherein the electrophotographic image forming apparatus further comprises a third spring to press the transfer roller onto the backup roller.

15. The electrophotographic image forming apparatus of claim 14, wherein the transfer roller is further to press the backup roller onto the third regulator.
